(19) United States
(12) Patent Application Publication
(10) Pub. No.: US 2004/0143586 A1
(43) Pub. Date: Jul. 22, 2004

(54) Method of controlling user application program

(75) Inventor: Sang Won Chung, Seoul (KR)

Correspondence Address: BACON & THOMAS, PLLC, 625 SLATERS LANE, FOURTH FLOOR, ALEXANDRIA, VA, 22314

(73) Assignee: Nexon Corporation, Seoul (KR)

(21) Appl. No.: 10/623,508

(22) Filed: Jul. 22, 2003

(30) Foreign Application Priority Data
Jan. 22, 2003 (KR) 2003-0004366

(51) Int. Cl. G06F 17/00

(52) U.S. Cl. 707/100

(57) ABSTRACT

The present invention relates to a method of controlling a user application program executed in a user's terminal, and more particularly, to a method of controlling a user application program, wherein the user application program can be executed while necessary data are downloaded from a predetermined server during the execution of the user application program.

The present invention for controlling a user application program executed in a client computer comprises the steps of hooking the file readout request for a file from the user application program; determining whether the file is stored in the client computer; if it is determined that the file has been stored in the client computer, transferring data of the file to the user application program; and if it is determined that the file has not yet been stored in the client computer, receiving some of the data of the file from a predetermined server with the file stored therein and transferring the received data to the user application program, the predetermined server being connected to the client computer through a network. According to an aspect of the present invention, the step of receiving the file readout request for the file from the user application program comprises the step of hooking the file readout request or mapping an original function for processing the file readout request to another function.

The method according to the present invention can be conveniently converted conventional package types of software products into online software, thereby obtaining an effect of online streaming and effectively preventing external hacking and cracking and illegal use of the software by maintaining connection with a server through a network.

### BACKGROUND OF THE INVENTION

1. Field of Invention

The present invention relates to a method of controlling a user application program executed in a user's terminal, and more particularly, to a method of controlling a user application program, wherein the user application program can be executed while necessary data are downloaded from a predetermined server during the execution of the user application program.

2. Description of the Prior Art

Heretofore, package games (offline games) are distributed to users in a state where game programs and data necessary for the game programs are stored in storage media such as CDs. However, there are many cases where package types of software products including such package games are illegally copied and then utilized by unauthorized users. Therefore, if such package types of software products are converted into online software, it is possible to obtain various advantages of online software such as automatic update as well as prevention of such illegal copy. Accordingly, there is a need for a method of conveniently converting such package types of software products into online software.

Further, even in case of an online game, the online game cannot be executed until all data required for execution of the online game are completely downloaded to a user's computer. However, the amount of data that a user should initially download more and more increases as the online game is further developed and complicated. Recently, the amount of data to be initially downloaded in order to execute an online game frequently exceeds 200 Mbytes. Since the amount of data to be initially downloaded is too large, there is a disadvantage in that an initial user of the online game cannot easily participate in the online game. Thus, there is a need for a method of executing an online game after partially downloading a small amount of data even though the size of data required for the execution of the entire online game is large.

### SUMMARY OF THE INVENTION

The present invention is conceived to solve the aforementioned problems in the prior art. An object of the present invention is to conveniently convert conventional package types of software products into online software, thereby obtaining an effect of online streaming and effectively preventing external hacking and cracking and illegal use of the software by maintaining connection with a server through a network.

Another object of the present invention is to easily convert the conventional package types of software products into online software, thereby periodically monitoring illegal copy of the package types of software products and preventing the illegal copy by interrupting execution of a possible, illegally-copied software product.

A further object of the present invention is to convert the conventional package types of software products into online software, thereby enabling pay-per-minute billing upon charging fees for the use of the software products.

A still further object of the present invention is to minimize the amount of data to be initially downloaded by causing files of online software to be downloaded based on blocks in the files rather than the entire files, thereby allowing users to easily enjoy an online game at an initial stage.

A still further object of the present invention is to optimize data to be downloaded by investigating patterns of data required by online software, and to minimize user's waiting time for download of the data and use of a bandwidth of a server by beforehand downloading necessary data through background P2P according to the investigated patterns of the data even when a user application program does not request readout of the data.

### BRIEF DESCRIPTION OF THE DRAWINGS

The above and other objects and features of the present invention will become apparent from the following description of preferred embodiments given in conjunction with the accompanying drawings, in which:

FIG. 1 is a view showing connection of a file server to client computers through a network according to the present invention.

FIG. 2 is a block diagram showing a relationship among a user application program installed in a client computer, an online streaming file library and a network interface according to the present invention.

FIG. 3 is a flowchart illustrating a procedure for processing the file readout request issued from the user application program executed in the client computer according to the present invention.

FIG. 4 is a flowchart illustrating a procedure for processing the file-writing request issued from the user application program executed in the client computer according to the present invention.

FIG. 5 shows a relationship between data blocks and priority files in a case where the priority files are constructed by profiling the data blocks in a file accessed by the user application program according to the present invention.

FIG. 6 is a view showing an index table constructed according to one embodiment of the present invention.

### DETAILED DESCRIPTION OF THE INVENTION

In order to achieve the above objects and solve the problems in the prior art, the present invention for controlling a user application program executed in a client computer comprises the steps of receiving a file readout request for a file from the user application program; determining whether the file is stored in the client computer; if it is determined that the file has been stored in the client computer, transferring data of the file to the user application program; and if it is determined that the file has not yet been stored in the client computer, receiving some of the data of the file from a predetermined server with the file stored therein and storing the some of the data in the client computer and forwarding the received data to the user application program, the predetermined server being connected to the client computer through a network. According to an aspect of the present invention, the step of receiving the file readout request for the file from the user application program comprises the step of hooking the file readout request or mapping an original function for processing the file readout request to another function.

According to another aspect of the present invention, there is provided a method of controlling a user application program comprising the steps of receiving a file-writing request for a file from the user application program; determining whether it is necessary to upload the file to a predetermined server that is connected to the client computer through a network; if it is determined that it is necessary to upload the file to the server, uploading the file to the server; and if it is determined that it is not necessary to upload the file to the server, writing the file in the client computer.

According to a further aspect of the present invention, there is provided a method of controlling a user application program comprising comprising the steps of receiving a file readout request for a file from the user application program; checking the user application program and data associated therewith, which are stored in a client computer, in response of the file readout request; and if it is confirmed from the check that the user application program and the data have been altered, notifying a predetermined server of the alteration, the predetermined server being connected to the client computer through a network.

According to a still further aspect of the present invention, there is provided a method of controlling a user application program comprising the steps of receiving a file readout request for a file from the user application program; performing predetermined authentication while connecting with a predetermined server at a predetermined time interval; and if the authentication fails, causing the user application program not to be executed by ignoring the file readout request.

According to a still further aspect of the present invention, there is provided a method of controlling a user application program comprising the steps of storing at least one of a plurality of data blocks in a data file, which is accessed by the user application program, as a priority file in a predetermined server; storing data offsets for the data blocks, sizes of the data blocks and priority file identifiers associated with the data blocks in an index storage means; receiving a data readout request for an arbitrary data block in the data file from the user application program; identifying a priority file corresponding to the arbitrary data block by referring to the index storage means; and receiving the identified priority file from the predetermined server and transferring the priority file to the user application program.

### DESCRIPTION OF THE PREFERRED EMBODIMENTS

Hereinafter, preferred embodiments of the present invention will be described in detail with reference to the accompanying drawings.

FIG. 1 is a view showing connection of a file server to client computers through a network according to the present invention.

Users connect with a predetermined online game server 104 through the Internet by using their client computers 102 and 103 in order to enjoy an online game. In case of a conventional package type of game software, it can be easily converted into online software according to the present invention so that the users connect with the game server 104 to enjoy the game when they want to do it. That is, even in case of such a conventional package game, the users can begin to enjoy the game just after downloading only some files or data rather than entire files or data of the game simply by connecting with the game server 104 without purchasing CDs or the like in accordance with the present invention.

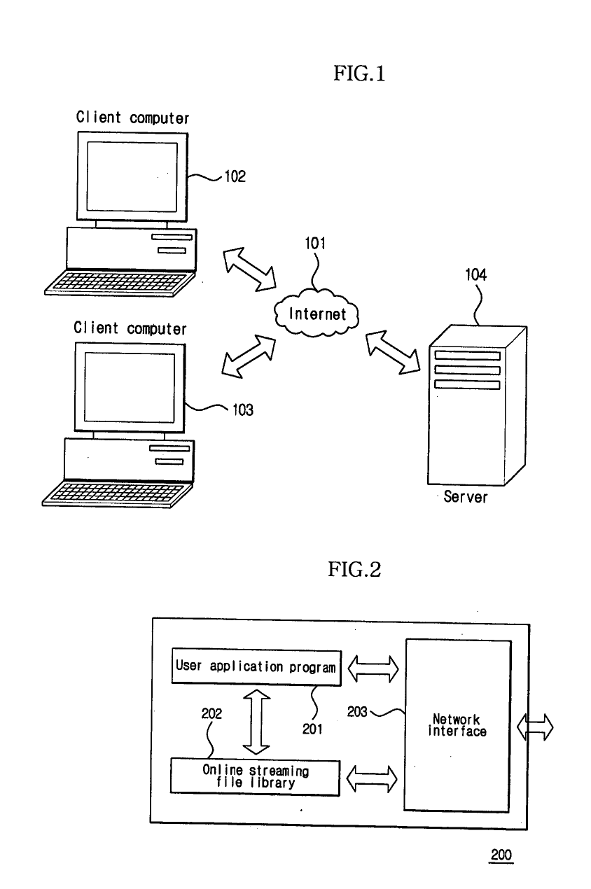

FIG. 2 is a block diagram showing a relationship among a user application program installed in a client computer, an online streaming file library and a network interface according to the present invention.

The user application program 201 is conventional package software as it is or a program partially modified from the conventional package software according to the present invention. Alternatively, the user application program 201 may be conventional online software. The present invention is to obtain various useful effects by converting conventional package software into online software. However, some of the spirit of the present invention can be easily applied to the conventional online software to obtain useful effects.

The online streaming file library 202 hooks and performs a file readout request and a file-writing request issued from the user application program 201 and also performs functions of maintaining connection with the server 104, monitoring illegal use of software, and the like. Further, the online streaming file library 202 performs a function of downloading necessary data from the server or adjacent other client computers on the network. The online streaming file library 202 may be implemented in different configurations other than a library.

The online streaming file library 202 hooks an application program interface (API) for input/output (I/O) of files on the level of an existing operating system. As for examples of the file I/O API on the level of the existing operating system, there are functions of CreateFile( ), ReadFile( ), WriteFile( ) and the like in the Windows operating system of Microsoft Corporation. In the Windows operating system, there is an import section for all Win32 API functions. The import section is a kind of jump vector table. For example, in case of the CreateFile( ) function, a pointer for the CreateFile( ) function is stored in the import section. Therefore, in a case where the CreateFile( ) function is used in an execution file (a file with an extension of “.exe” in the Windows operating system), the execution file refers to the import section to obtain the pointer for the CreateFile( ) function and executes a function designated by the pointer. API hooking can be performed by changing addresses of respective I/O functions in the import section into addresses of other functions. For example, if the pointer for the CreateFile( ) function in the import section is changed to designate an address of another function other than an address of the CreateFile( ) function provided by the operating system, the function other than the CreateFile( ) function provided by the operating system is executed when the user application program executes the CreateFile( ).

To perform the API hooking, an API hooking initialization function and an API hooking end function are added to the beginning and end of a main function (e.g., winmain( ) function in the Windows operating system) of the user application program. The API hooking initialization function is a function provided by the present invention and performs a function of changing pointers for respective API functions in the import section of the user application program into pointers for I/O functions of the present invention. The API end function performs a function of restoring the changed import section to its original state. Therefore, according to the present invention, conventional package software can be converted into online software by adding only the two functions to the main function of the conventional package software. According to another embodiment of the present invention, hooking for an entry point itself of the main function is performed. This method is similar to, for example, a method by which a computer virus program adds its own codes to execution files. According to this embodiment, there is an advantage in that the package software can be converted into the online software without any modifications to the application program.

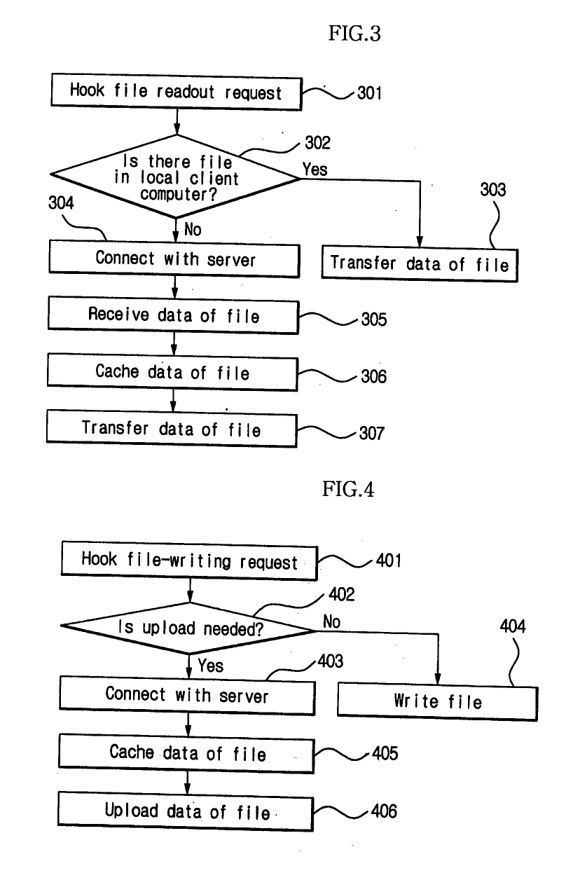

FIG. 3 is a flowchart illustrating a procedure for processing the file readout request issued from the user application program executed in the client computer according to the present invention.

First, the jump vector table of the I/O API functions for the API hooking according to the present invention has been changed to perform the I/O API functions of the present invention. In step 301, the file readout request is received from the user application program 201 and then hooked. That is, the ReadFile( ) function of the user application program 201 is performed. The performance of the ReadFile( ) function is hooked, and an online streaming file I/O API function of the present invention is performed. The online streaming file I/O API function of the present invention is stored in the online streaming file library 202.

In step 302, the online streaming file I/O API function of the present invention determines whether a file requested by the user application program 201 is stored in a client computer in which the user application program 201 is installed. If the file requested by the user application program 201 has been stored in the client computer, data of the file are read out and transferred to the user application program 201 in step 303. The data of the file may be entire data of the file or some of data included in the file. For example, in a case where the user application program is a predetermined game program, if there is a file that stores graphic data required for execution of the game program, the game program requests readout of the file storing the required graphic data and the file storing the graphic data is stored in the client computer, the file is read out and then transferred to the game program.

If it is determined in step 302 that the data requested by the user application program 201 has not yet been stored in the local client computer, the online streaming file I/O API function connects with the predetermined server 104 through the network interface 203 in step 304. The server is connected to the client computer through the network. The server stores all data required by the user application program 201.

The online streaming file I/O API function receives the data of the file from the server 104 in step 305 and caches the received data in the local client computer in step 306. Due to such caching, there are advantages in that identical data are not repeatedly downloaded and data expected to be downloaded using a concept of priority file, which will be described later, can be beforehand downloaded. For example, in a case where currently required data are Block 5 of File 1, if it is determined that the user application program 201 has used Block 6 together with Block 5 from previous investigation into the operation of the user application program 201 while executing the user application program 201, Blocks 5 and 6 are downloaded from the server 104 so that they are cached.

In step 307, the online streaming file I/O API function transfers the data of the file received from the server 104 to the user application program 201. Then, the user application program 201 is continuously executed.

For example, assume that although the total size of data files required for entire execution of game software is 200 Mbytes, the size of graphic data that the game software requires in order to display a current screen is 3 Mbytes and this graphic data have not yet stored in a local client computer. At this time, connection with a server storing the graphic data is made and the required graphic data are downloaded and then used. Thus, according to the present invention, a user can easily enjoy an online game without initially downloading a large amount of data. Further, even in a case where package game software is converted into online software according to the present invention, the user can enjoy the game by downloading only some of necessary data from the server whenever they are required. That is, according to the present invention, the user application program can be executed without beforehand storing the entire data required for the execution of the user application program in the local client computer.

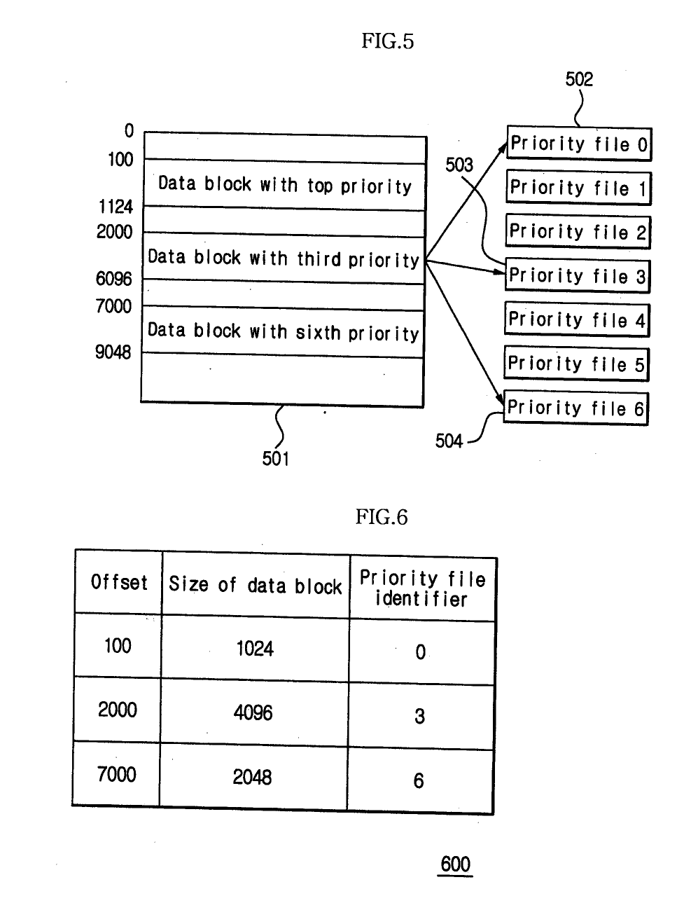

According to a further embodiment of the present invention, the operations of reading out and receiving the data of the file are performed by receiving some of the data, and the operation of receiving some of data is performed by using data offsets for the file and the sizes of some of the data. This operation will be specifically described later with reference to FIGS. 5 and 6.

According to a still further embodiment of the present invention, while the user application program 201 executed in one of the client computers 102 does not issue the file readout request, it is determined whether data required for the execution of the user application program 201 have been stored in another one of the client computers 103 adjacent to the client computer 102 on the network. If the necessary data have been stored in the client computer 103, the data are retrieved from the client computer 103 and then stored in the client computer 102. The client computer 103 may also retrieve data from the client computer 102 in the same manner. A program for performing such a retrieving operation may be run as a background program simultaneously with start of the execution of the user application program 201 or may be run in the client computer 102 or 103 independently from start and end of the execution of the user application program 201. According to the present invention, since necessary data are beforehand downloaded and stored in the local client computer before the user application program requests the data, the user application program can be efficiently executed and a load on the server 104 can be reduced.

According to a still further embodiment of the present invention, the data readout request issued from the user application program 201 is hooked. If the data have been stored in the local client computer, the stored data are transferred to the user application program 201. If the data have not yet been stored in the local client computer, it is determined whether the data have been stored in other adjacent client computers on the network. If the data have been stored in one of other client computers, the data are downloaded using P2P. If the data have not yet been stored in any one of client computers, connection with the server is made to download the data.

According to a still further embodiment of the present invention, the data readout request issued from the user application program 201 is hooked. The user application program 201 and data associated therewith stored in the client computer are checked in response to the data readout request. If the user application program 201 or the data have been altered, the user application program 201 or the data may be considered as having been hacked or cracked. Then, the server 104 is notified of this alteration. The determination on such alteration can be achieved by using various methods of checking whether data have been altered, including CRC check and the like. Therefore, according to the present invention, since it is checked whether the user application program has been hacked or cracked, proper measures to cope with the hacking or cracking can be taken.

According to a still further embodiment of the present invention, the data readout request issued from the user application program 201 is hooked. Then, the connection with the server 104 is made at predetermined time intervals to perform predetermined authentication. The predetermined time intervals may be constant or inconsistent time intervals. The authentication is authentication regarding whether a user of the user application program is a lawful user. If the authentication fails, the online streaming file I/O API function dose not perform any processes with respect to a future file readout request issued from the user application program or causes an error message to be displayed on a user's display so that the user application program cannot be properly executed. According to this embodiment, illegal use of a program such as illegal copy can be prohibited. Further, since a package program can be easily converted into an online program, fees for the use of the program can be charged based on pay-per-minute billing. That is, although the package program is difficult to employ the pay-per-minute billing, a user can be billed based on the pay-per-minute billing since the package program is converted into the online program and use time of the user application program is managed by the server 104. Generally, in case of a package game, there are many cases where users fully enjoy the game during about one month and do not enjoy the game any more thereafter. Thus, if the users merely pay fees for enjoying the game during about one month, they can fully enjoy the game. Accordingly, there is an advantage in that the users can enjoy a game program at inexpensive costs.

FIG. 4 is a flowchart illustrating a procedure for processing the file-writing request issued from the user application program executed in the client computer according to the present invention.

In step 401, the file-writing request is received from the user application program 201 and then hooked. That is, the WriteFile( ) function of the user application program 201 is performed. The performance of the WriteFile( ) function is hooked, and an online streaming file I/O API function of the present invention corresponding to the WriteFile( ) function is performed. The online streaming file I/O API function is stored in the online streaming file library 202.

In step 402, the online streaming file I/O API function of the present invention determines whether it is necessary to upload a file, which has been requested to be written by the user application program 201, to the server 104. If it is not necessary to upload the file, which has been requested to be written by the user application program 201, to the server 104, the user application program 201 stores the file in the local client computer in step 404. For example, data that are not required to be managed by the server 104 among user-dependent data can be stored in and managed by only the local client computer. Whether certain data are required to be uploaded to the server is determined by a provider of a computer program according to the present invention, and resultant logic is included in the online file I/O API function.

If it is necessary to upload the file, which has been requested to be written by the user application program 201, to the server 104, the online streaming file I/O API function connects with the predetermined server 104 through the network interface 203 in step 403. The server 104 is connected to the client computer through the network.

The online streaming file I/O API function caches data of the file, which will be uploaded to the server 104, in the local client computer in step 405. Due to such caching, in a case where identical data are read out again, the data need not be repeatedly downloaded. Thus, the efficiency of execution of the program can be improved.

In step 406, the online streaming file I/O API function uploads the data of the file, which will be uploaded, to the server 104.

FIG. 5 shows a relationship between data blocks and priority files in a case where the priority files are constructed by profiling the data blocks in a file accessed by the user application program according to the present invention.

For the sake of easy explanation of this embodiment, assume that the user application program is a game program with a name of “game.exe” and one of data files required by “game.exe” is “data1.dat.” “Data1.dat” is a data file with a size of 10 Mbytes. A main function of “game.exe” is partially modified so that a file I/O API function can be hooked by the online streaming file I/O API function.

First, the step of performing the profiling for searching for data to which the user application program sequentially refers will be described.

While the user application program 201 is executed, data to which the user application program 201 refers are identified. According to one embodiment of the present invention, data to which the user application program 201 refers for a predetermined period of time while it is executed are grouped into one file. This is an example of the priority file of the present invention. The priority file may be a combination of some of data stored in one file or a plurality of files. That is, one priority file may be created by combining Data Block A included in File 1 with Data Block B included in File 2. At this time, since it is difficult to understand the structure of data downloaded during the execution of the user application program, there is an advantage in that hacking and cracking of the program become more difficult.

One priority file is created by grouping data that are referred to at a time interval of 5 seconds during the execution of “game.exe.” For example, if data that are requested to be read out in a range of 0 to 5 seconds after the execution of “game.exe” are data with a size of 1024 bytes from a data offset of 100 in “data1.dat,” the data with the size of 1024 bytes from the data offset of 100 in “data1.dat” are first stored as Priority File 0 502. Data that are requested to be read out in a range of 5 to 10 seconds after the execution of “game.exe” are stored as Priority File 1. In the embodiment shown in FIG. 5, there is no file readout request in a range of 5 to 15 seconds after the execution of “game.exe.” Data that are requested to be read out in a range of 15 to 20 seconds after the execution of “game.exe” are data with a size of 4096 bytes from a data offset of 2000 in “data1.dat,” and then stored as Priority File 3 503. In this embodiment, data requested to be read out at the time interval of 5 seconds are stored as one priority file, and no priority file is created and only the number of the priority file is increased in the absence of a file readout request. However, according to another embodiment of the present invention, it is also possible to change the time interval or a method of creating the priority file. For example, after the creation of Priority File 0, priority files to be subsequently created are named Priority File 1, Priority File 2 and the like so that the number of the priority file cannot jump. In any case, data with a higher possibility that the user application program requires during the execution thereof are used by being designated as data with a higher priority. In other words, the data may be managed as individual files by priorities, or may be provided to the user application program by assigning only priorities to respective data blocks in one file, managing only the priorities of the data blocks and reading out necessary data blocks. The priority files created in such a way are stored in the server 104.

According to a further embodiment of the present invention, the priorities are not determined in order of higher possibilities of data blocks that the user application program requires during the execution thereof. The priorities may be determined in consideration of other factors such as the size of data. When there are data readout requests from the user application program and data with different priorities are required, the data readout requests are processed in order of higher priorities of data, and a data readout request first issued from the user application program is first processed with respect to data with the same priority.

According to a still further embodiment of the present invention, in case of data with a higher priority determined as above, as soon as a data readout request is received from the user application program, the relevant data are received from the server 104. However, in case of data with a lower priority, the data are downloaded from one of adjacent other client computers by using background P2P.

When the priority files are created in such a manner, the priority files are created in order of data required as the user application program begins to be executed. Therefore, it is statistically expected that the user application program requests data of Priority File 0 and subsequently data of Priority File 3. Thus, while there is no data readout request from the user application program, for example, between 5 and 15 seconds after execution of “geme.exe” in this embodiment, Priority File 3 is beforehand downloaded through a background task to the local client computer. Accordingly, since the data required when the user executes the user application program are beforehand stored in the local client computer, it is not necessary to wait for download of the data when they are required.

Meanwhile, since commands first issued by respective users during the execution of the user application program may be different from one another, the order of data requested by the user application program of each user may also be different from one another. According to a still further embodiment of the present invention, in order to cope with such a case, patterns in which a plurality of users utilize the user application program are analyzed and priority files are then created based on the patterns. To this end, a variety of conventional statistical methods may be utilized. For example, the plurality of users are caused to execute the user application program, and data requested by the respective users are analyzed. Then, a predetermined weight is assigned to data first requested by each user, and data most requested within a given period of time can be stored as a priority file for the given period of time. According to a still further embodiment of the present invention, priority files are arbitrarily created at an initial stage and the frequency of data that the users request the server 104 to transfer while utilizing the user application program are investigated. Then, priority files are created again by assigning priorities thereto in order of the frequency of the requests for data.

FIG. 6 is a view showing an index table constructed according to one embodiment of the present invention.

The index table 600 includes information on correspondence of priority files to respective data blocks with predetermined sizes from predetermined data offsets and is created upon profiling the data. On the assumption that there is one data file, the index table shown in FIG. 6 does not include information on the data file. However, in case of a plurality of data files, the index table includes information on correspondence of data files to priority files. FIG. 6 shows the index table 600 for the priority files constructed according to the profiling of FIG. 5.

Now, a procedure performed when the user application program issues the data readout request will be described in detail with reference to FIG. 3 and the index table of FIG. 6.

A case where the user application program, “game.exe,” issues the file readout request for data with the size of 1024 bytes from the data offset of 2500 in the data file, “data1.dat,” will be explained by way of example. The user application program can request readout of data with a predetermined size from a specific offset in a specific file by using the ReadFile( ) function. The ReadFile( ) function of the user application program is hooked by the online streaming file I/O API function.

The online streaming file I/O API function refers to the index table 600 in order to determine which priority file stores the required data. As a result of referring to the index table 600, it is identified that a priority file corresponding to the data is Priority File 3. The online streaming file I/O API function checks whether Priority File 3 has been stored in the local client computer.

If it is checked that Priority File 3 has been stored in the local client computer, data of the file are read out and only the data with the size of 1024 bytes requested by “game.exe” are transferred to “game.exe.”

If it is checked that Priority File 3 has not yet been stored in the local client computer, the online streaming file I/O API function connects with the predetermined server 104 through the network interface 203. The server 104 is connected to the client computer through the network and has stored all priority files. According to one embodiment of the present invention, the server 104 stores all data that are not included in the priority files.

The online streaming file I/O API function receives Priority File 3 from the server 104 and caches received Priority File 3 in the local client computer. Due to such caching, it is not necessary to again download Priority File 3 in a case where the user application program requests other data included in Priority File 3.

The online streaming file I/O API function reads out Priority File 3 received from the server 104 and transfers only the data requested by “game.exe” to the user application program 201, “game.exe.” Then, the user application program 201 is continuously executed.

In the aforementioned embodiments, the receipt of the file readout request issued from the user application program has been described in connection with the method of hooking the file readout request. However, from the teaching disclosed herein, those skilled in the art may implement the present invention by using a function re-mapping method of mapping file I/O functions to other functions in addition to the hooking method, and may also employ other equivalent methods.

In addition, embodiments of the present invention further relate to computer readable media that include program instructions for performing various computer-implemented operations. The media may also include, alone or in combination with the program instructions, data files, data structures, tables, and the like. The media and program instructions may be those specially designed and constructed for the purposes of the present invention, or they may be of the kind well known and available to those having skill in the computer software arts. Examples of computer-readable media include magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). The media may also be a transmission medium such as optical or metallic lines, wave guides, etc. including a carrier wave transmitting signals specifying the program instructions, data structures, etc. Examples of program instructions include both machine code, such as produced by a compiler, and files containing higher level code that may be executed by the computer using an interpreter.

As described above, the method according to the present invention can be conveniently converted conventional package types of software products into online software, thereby obtaining an effect of online streaming and effectively preventing external hacking and cracking and illegal use of the software by maintaining connection with a server through a network.

Additionally, according to the present invention, there can easily be converted the conventional package types of software products into online software, thereby periodically monitoring illegal copy of the package types of software products and preventing the illegal copy by interrupting execution of a possible, illegally-copied software product.

Additionally, according to the present invention, there can be converted the conventional package types of software products into online software, thereby enabling pay-per-minute billing upon charging fees for the use of the software products.

Additionally, according to the present invention, there can be minimized the amount of data to be initially downloaded by causing files of online software to be downloaded based on blocks in the files rather than the entire files, thereby allowing users to easily enjoy an online game at an initial stage. That is to say, according to the present invention, a program can be executed even though all data of the program have not yet been stored in a local computer before execution of the program. Further, an on-demand data request is enabled.

Additionally, according to the present invention, there can be optimized data to be downloaded by investigating patterns of data required by online software, and be minimized user's waiting time for download of the data and use of a bandwidth of a server by beforehand downloading necessary data through background P2P according to the investigated patterns of the data even when a user application program does not request readout of the data.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method of controlling a user application program executed in a client computer, comprising the steps of:
receiving a file readout request for a file from the user application program;
determining whether the file is stored in the client computer;
if it is determined that the file has been stored in the client computer, forwarding data of the file to the user application program; and
if it is determined that the file has not yet been stored in the client computer, receiving some of the data of the file from a predetermined server with the file stored therein and storing the some of the data in the client computer and forwarding the received data to the user application program, the predetermined server being connected to the client computer through a network.

2. The method as claimed in claim 1, wherein the step of receiving some of the data is performed by using data offsets of the file and the size of some of the data to be received.

3. The method as claimed in claim 1, further comprising the step of continuously executing the user application program in a state where only some of the data are received but all data of the file have not yet been received.

4. The method as claimed in claim 1, wherein the step of receiving the file readout request for the file from the user application program comprises the step of hooking the file readout request or mapping an original function for processing the file readout request to another function.

5. The method as claimed in claim 1, further comprising the step of receiving the data of the file from the predetermined server with the file stored therein and caching the received data in the client computer.

6. The method as claimed in claim 1, further comprising the steps of:
identifying a second client computer with the file stored therein; and
receiving the file from the identified second client computer and transferring the received file to the user application program.

7. The method as claimed in claim 1, further comprising the step of:
while the file readout request is not received from the user application program, receiving data expected to be required by the user application program from a second client computer with the data stored therein and storing the received data.

8. The method as claimed in claim 7, wherein determination on the data expected to be required by the user application program is made based on data that have been requested by the user application program upon previous execution of the user application program.

9. A method of controlling a user application program executed in a client computer, comprising the steps of:
receiving a file-writing request for a file from the user application program;
determining whether it is necessary to upload the file to a predetermined server that is connected to the client computer through a network;
if it is determined that it is necessary to upload the file to the server, uploading the file to the server; and
if it is determined that it is not necessary to upload the file to the server, writing the file in the client computer.

10. A method of controlling a user application program, comprising the steps of:
receiving a file readout request for a file from the user application program;
checking the user application program and data associated therewith, which are stored in a client computer, in response of the file readout request; and
if it is confirmed from the check that the user application program and the data have been altered, notifying a predetermined server of the alteration, the predetermined server being connected to the client computer through a network.

11. The method as claimed in claim 10, wherein the checking step is performed by using CRC check.

12. A method of controlling a user application program, comprising the steps of:
receiving a file readout request for a file from the user application program;
performing predetermined authentication while connecting with a predetermined server at a predetermined time interval; and
if the authentication fails, causing the user application program not to be executed by ignoring the file readout request.

13. The method as claimed in claim 12, wherein fees for the use of the user application program are charged to a user on the basis of pay-per-minute billing.

14. A method of controlling a user application program executed in a client computer, comprising the steps of:
storing at least one of a plurality of data blocks in a data file, which is accessed by the user application program, as a priority file in a predetermined server;
storing data offsets for the data blocks, sizes of the data blocks and priority file identifiers associated with the data blocks in an index storage means;
receiving a data readout request for an arbitrary data block in the data file from the user application program;
identifying a priority file corresponding to the arbitrary data block by referring to the index storage means; and
receiving the identified priority file from the predetermined server and transferring the priority file to the user application program.

15. The method as claimed in claim 14, further comprising the steps of:
identifying a second client computer with the priority file stored therein; and
receiving the priority file from the identified second client computer.

16. The method as claimed in claim 14, further comprising the step of:
while the file readout request is not received from the user application program, receiving a priority file expected to be required by the user application program from a second client computer with the priority file stored therein and storing the received priority file.

17. The method as claimed in claim 16, wherein determination on the priority file expected to be required by the user application program is made based on priority files that have been requested by the user application program upon previous execution of the user application program.

18. A computer-readable recording medium on which a program for performing a method according to any one of claims 1 to 17 is recorded.
